(19) United States
(12) Patent Application Publication
(10) Pub. No.: US 2019/0061398 A1
(43) Pub. Date: Feb. 28, 2019

(54) PRINTED LAMINATE WITH DIGITAL PRINTING AND METHOD FOR MANUFACTURE

(71) Applicant: WILSONART LLC, Austin, TX (US)

(72) Inventors: Arvind S. Karthikeyan, Temple, TX (US); Mahesh Subramanian, Centerville, OH (US); Rajesh Ramamurthy, Temple, TX (US)

(21) Appl. No.: 16/109,862

(22) Filed: Aug. 23, 2018

Related U.S. Application Data
(60) Provisional application No. 62/549,179, filed on Aug. 23, 2017.

(51) Int. Cl. B41M 5/00; B41M 7/00; B32B 21/02; B32B 38/00; B32B 27/40; B32B 27/30

(52) U.S. Cl. CPC B41M 5/0047; B41M 7/0081; B32B 21/02; B41M 7/0045; B32B 38/145; B32B 2375/00; B32B 27/308; B32B 2451/00; B32B 2305/72; B29K 2995/0089; B32B 27/40

(57) ABSTRACT

A digitally printed decorative surfacing material includes a base layer of vulcanized fiber with ink on a top surface thereof, the base layer and the ink defining a printed vulcanized fiber base layer. The digitally printed decorative surfacing material also includes a top coat layer applied to the printed vulcanized fiber base layer to provide scratch resistance and other physical properties. The digitally printed decorative surfacing material is manufactured by providing a base layer of vulcanized fiber, applying ink on a top surface of the base layer thereby defining a printed vulcanized fiber base layer, and applying a top coat layer to the printed vulcanized fiber base layer to provide scratch resistance and other physical properties.

### CROSS REFERENCE TO RELATED APPLICATION

This application claims the benefit of U.S. Patent Application No. 62/549,179, entitled “PRINTED LAMINATE WITH DIGITAL PRINTING AND METHOD FOR MANUFACTURE,” filed Aug. 23, 2017.

### BACKGROUND OF THE INVENTION

### 1. Field of the Invention

The present invention relates to decorative surfacing materials. More particularly, the present invention relates to digitally printed decorative surfacing materials.

### 2. Description of the Related Art

The world of decorative surfacing materials is constantly evolving to provide consumers with cutting edge technologies to meet both their aesthetic desires and functional needs. Meeting both the aesthetic desires and functional needs of consumers forces engineers and scientists within the industry to constantly evaluate the current needs of society and address these needs with real world products. The present invention provides a decorative surfacing material that advances the industry by providing a durable, customizable, and cost effective surfacing material.

### SUMMARY OF THE INVENTION

It is, therefore, an object of the present invention to provide a digitally printed decorative surfacing material. The digitally printed decorative surfacing material includes a base layer of vulcanized fiber with ink on a top surface thereof, the base layer and the ink defining a printed vulcanized fiber base layer. The digitally printed decorative surfacing material also includes a top coat layer applied to the printed vulcanized fiber base layer to provide scratch resistance and other physical properties.

It is also an object of the present invention to provide a digitally printed decorative surfacing material wherein the top coat layer includes a clear hot melt polyurethane layer and a clear UV cured acrylic coating layer.

It is another object of the present invention to provide a digitally printed decorative surfacing material wherein the base layer is a vulcanized fiber sheet.

It is a further object of the present invention to provide a digitally printed decorative surfacing material wherein the ink is UV ink.

It is also an object of the present invention to provide a digitally printed decorative surfacing material including a substrate to which the digitally printed decorative surfacing material is secured.

It is another object of the present invention to provide a digitally printed decorative surfacing material wherein the top coat layer includes texturing.

It is a further object of the present invention to provide a method for manufacturing a digitally printed decorative surfacing material. The method includes providing a base layer of vulcanized fiber, applying ink on a top surface of the base layer thereby defining a printed vulcanized fiber base layer, applying a top coat layer to the printed vulcanized fiber base layer to provide scratch resistance and other physical properties.

It is also an object of the present invention to provide a method for manufacturing a digitally printed decorative surfacing material wherein the step of applying a top coat layer includes applying a clear hot melt polyurethane layer.

It is another object of the present invention to provide a method for manufacturing a digitally printed decorative surfacing material wherein the step of applying a top coat layer further includes applying a clear UV cured acrylic coating layer over the clear hot melt polyurethane layer.

It is a further object of the present invention to provide a method for manufacturing a digitally printed decorative surfacing material wherein the step of applying a top coat includes texturing the top coat.

It is also an object of the present invention to provide a method for manufacturing a digitally printed decorative surfacing material wherein the base layer is a vulcanized fiber sheet.

It is another object of the present invention to provide a method for manufacturing a digitally printed decorative surfacing material wherein the ink is UV ink, and the step of applying ink include subjecting the ink to UV curing.

It is a further object of the present invention to provide a method for manufacturing a digitally printed decorative surfacing material including securing the digitally printed decorative surfacing material to a substrate.

It is also an object of the present invention to provide a method for manufacturing a digitally printed decorative surfacing material wherein the step of applying a top coat includes texturing the top coat.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of a decorative surfacing material in accordance with the present invention secured to a substrate.

FIG. 2 is a schematic of a vulcanized fiber base layer.

FIG. 3 is a schematic of a vulcanized fiber base layer after printing.

FIG. 4 is a schematic of a vulcanized fiber base layer after printing and the application of a top layer.

FIG. 5 is a schematic of a vulcanized fiber base layer after printing, the application of a top layer, and the a protective film, that is, the decorative surfacing material of the present invention.

FIG. 6 is a schematic of a decorative surfacing material in accordance with an alternate embodiment.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

Referring to the various embodiments disclosed herein, the present invention generally relates to a digitally printed decorative surfacing material 100 (for example, printed laminates) and a method for the manufacture of digitally printed surfacing material 100. In particular, the present invention relies upon a combination of digital printing and various coatings used in conjunction with a base layer of vulcanized fiber 10 to produce a durable, cost effective, and aesthetically pleasing surfacing material. It is appreciated that texturing may be applied to the digitally printed decorative surfacing material 100, offering various advantages, both aesthetically and functionally.

The present invention includes a base layer of vulcanized fiber 10. Because of the inherent characteristics of the vulcanized fiber base layer 10, no pretreatment s required as vulcanized fiber base layer 10 is highly receptive to digital printing using UV inks. It is also appreciated that water based inks can also be used, although the clarity may not be as good as that achieved with UV inks. The vulcanized fiber base layer 10 is printed upon using digital printing techniques to produce a printed base layer 13. A top coat layer 14 is applied to the printed vulcanized fiber base layer 10 to provide scratch resistance and other physical properties. In accordance with a preferred embodiment, and as will be discussed below in greater detail, the top coat layer 14 includes a clear hot melt polyurethane layer 16 followed by a clear UV cured acrylic coating layer 18.

As those skilled in the art will appreciate, vulcanized fiber sheets are laminated plastics composed of only cellulose. The cellulose is processed in a manner well known to those skilled in the art to produce durable, thin and inexpensive sheets that are used in accordance with the present invention. Vulcanized fiber sheets are typically formed from a cotton base that has been partially gelatinized by dissolving some of the cotton cellulose with an acid, such as a Bronsted acid (e.g., sulfuric acid) or a Lewis acid (e.g., zinc chloride). The excess acid is then leached out of the fiber, and the gelatinized fiber base is pressed together with other plies of cellulose treated in a similar manner to form a multiple ply product referred to in the industry as a “Vulcanized Fiber Sheet.” In particular, once the fiber is leached substantially free of the acid, it is dried to a moisture content of 5 to 6 percent and pressed to a desired thickness. Where a continuous process is employed the vulcanized fiber is sheeted or wound up into rolls for use in accordance with the present invention. The density of the finished vulcanized fiber is 2 to 3 times greater than the cellulose from which it starts. The density increase is the result of 10% machine direction shrinkage, 20% cross machine direction shrinkage, and 30% shrinkage in thickness. In accordance with a preferred embodiment, the present invention will employ conventional, off the shelf vulcanized fibers.

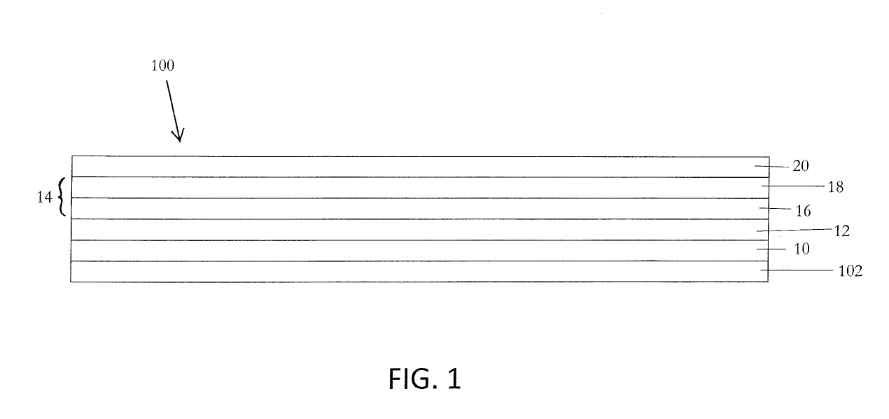

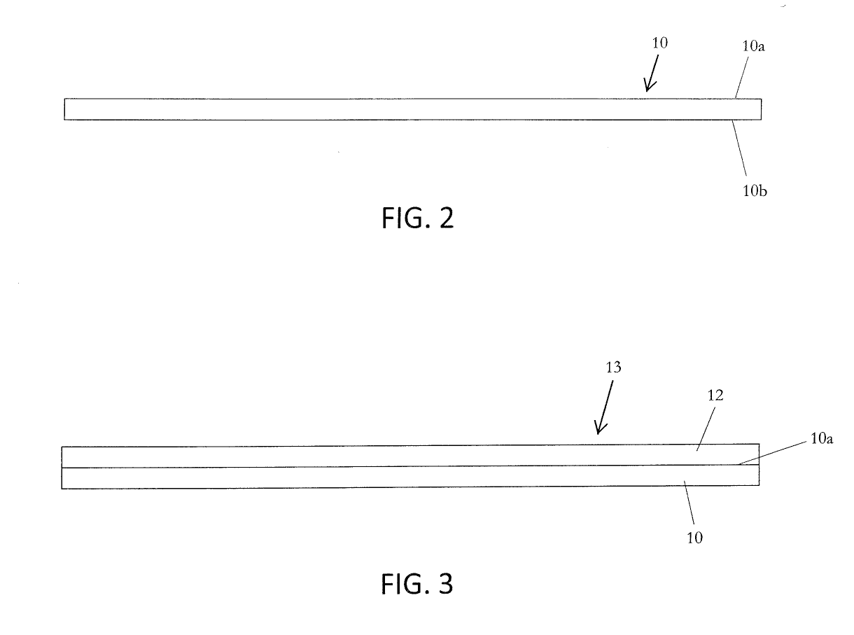

With reference to the embodiment disclosed with reference to FIGS. 1 to 5, the manufacture of a decorative surfacing material 100 is disclosed. After the top and bottom surfaces 10a, 10b of a vulcanized fiber base layer 10 are brushed clean, the top surface 10a of vulcanized fiber base layer 10 is digitally printed with UV inks 12. As discussed above, water based inks may also be used, and where it is desired to use water based inks, it may be advantageous to treat the vulcanized fiber base layer with a priming layer to prepare the vulcanized fiber substrate for printing with the water based inks.

The vulcanized fiber base layer 10 is printed digitally using a scanning or single pass digital printer. As discussed above, UV ink or water based ink may be used. Where UV ink is employed, the printing is followed by UV curing as is known in the art. Where water based ink is employed the printing is followed by a drying process as is known in the art.

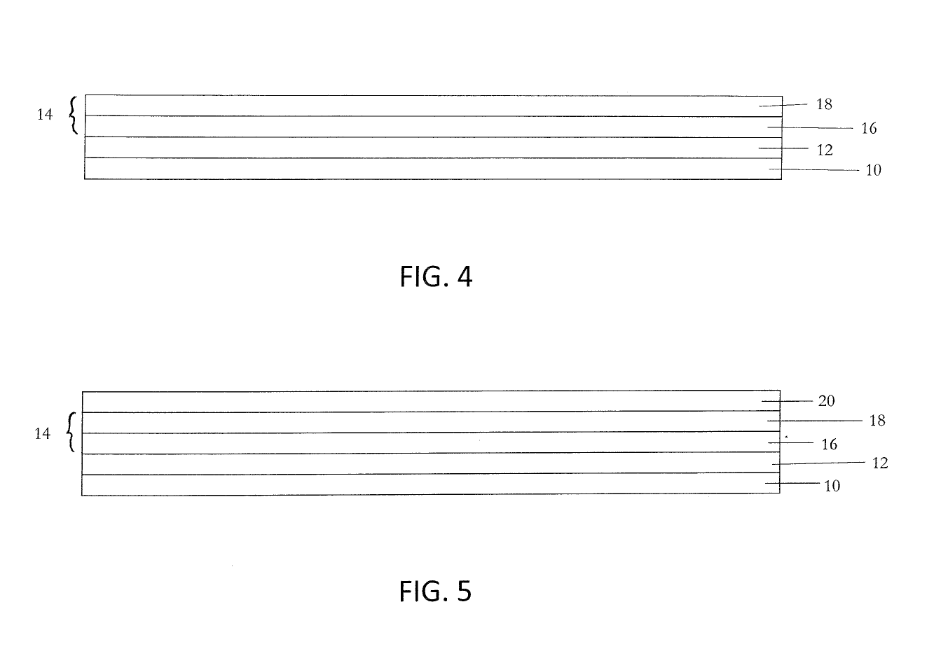

Once the vulcanized fiber base layer 10 is printed, that is, the printed base layer 13 is formed, a top coat layer 14 is applied over the UV inks 12, that is, the top coat layer 14 is applied to an upper surface 13a of the printed base layer 13 (see FIG. 4). The top coat layer 14 in accordance with a preferred embodiment of the present invention includes a first top coat layer 16 of clear hot melt polyurethane and a second top coat layer 18 of clear UV cured acrylic. The coat weight of the clear hot melt polyurethane first top coat layer 16 determines various functional characteristics of the final product and these characteristics are ultimately balanced in determining the coat weight of the clear hot melt polyurethane first top coat layer 16 applied to the printed vulcanized fiber base layer 10. In particular, increased coat weight will result in improved impact resistance and an increased resistance to abrasion. It is also appreciated, the hot melt polyurethane may contain aluminum oxide to enhance wear and scratch resistance. Thereafter, a clear UV cured acrylic second top coat layer 18 is applied to the clear hot melt polyurethane first top coat layer 16. The resulting product is fully cured and a protective film 20 is applied to the upper surface thereof so as to cover the top coat layer 14. The decorative surfacing material 100 is then ready for use.

The decorative surfacing material described above may be secured to other substrates 102 where greater support and rigidity are desired. For example, substrates 102 to which the decorative surfacing material 100 of the present invention may be secured include a pre-cured plastic laminate, such as glass fiber-reinforced thermoset polyester resin laminates and the like; polyvinyl chloride materials; polyolefinic materials; wood products, such as hardboard, wood waste or particle boards, plywood and the like; mineral-based boards, such as, cement-asbestos board, sheet rock, plaster board, and the like; or a combination of substrates.

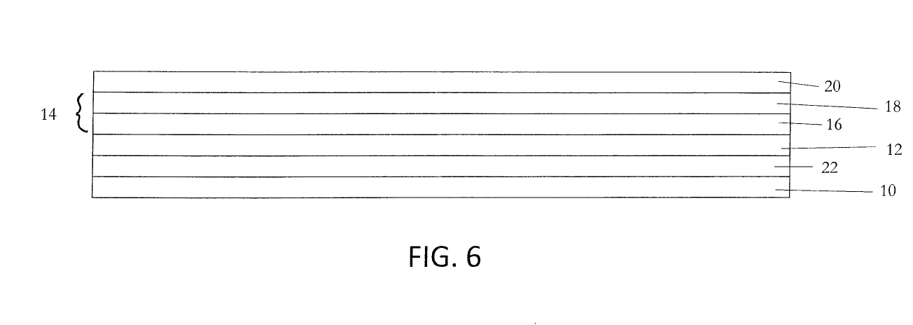

With reference to FIG. 6, it is also appreciated that texturing may be applied to the decorative surfacing material 100 via the application of a textured layer 22 to the top surface 10a of the vulcanized fiber base layer 10 prior to printing. Thereafter, printing, the top coat layer, and the protective films are applied as discussed above. Where texturing is desired, such a texturing layer 22 is applied prior to printing and preferably in a manner as disclosed in U.S. Pat. No. 9,199,428, entitled “MULTI-LAY ADDITIVE TEXTURE LAMINATES AND METHODS,” which is incorporated herein by reference. Briefly, the methodology of the '428 patent provides for the production of a multi-layer additive texture high definition image. The method requires constructing a build layer, wherein the build layer is composed of one or more build levels, and each of the build levels includes a surface having one or more heights. The heights are varied in correspondence with an image that is to be subsequently printed upon the primed and textured base layer. By layering in this manner, a three dimensional textured surface is achieved.

The methodology of the '428 patent employs computers in implementing the method for creating high definition textured surfacing material. In accordance with this element of the methodology of the '428 patent, a surfacing material image is received and a build value is assigned to each of the one or more image properties in the surfacing material image. The build values relate to a texture, specific to the surfacing material image. These build values are applied in the creation of the build layer discussed above.

While the preferred embodiments have been shown and described, it will be understood that there is no intent to limit the invention by such disclosure, but rather, is intended to cover all modifications and alternate constructions falling within the spirit and scope of the invention.

1. A digitally printed decorative surfacing material, comprising:
a base layer of vulcanized fiber with ink on a top surface thereof, the base layer and the ink defining a printed vulcanized fiber base layer;
a top coat layer applied to the printed vulcanized fiber base layer to provide scratch resistance and other physical properties.

2. The digitally printed decorative surfacing material according to claim 1, wherein the top coat layer includes a clear hot melt polyurethane layer and a clear UV cured acrylic coating layer.

3. The digitally printed decorative surfacing material according to claim 1, wherein the base layer is a vulcanized fiber sheet.

4. The digitally printed decorative surfacing material according to claim 1, wherein the ink is UV ink.

5. The digitally printed decorative surfacing material according to claim 1, further including a substrate to which the digitally printed decorative surfacing material is secured.

6. The digitally printed decorative surfacing material according to claim 1, wherein the top coat layer includes texturing.

7. A method for manufacturing a digitally printed decorative surfacing material, comprising:
providing a base layer of vulcanized fiber;
applying ink on a top surface of the base layer thereby defining a printed vulcanized fiber base layer;
applying a top coat layer to the printed vulcanized fiber base layer to provide scratch resistance and other physical properties.

8. The method according to claim 7, wherein the step of applying a top coat layer includes applying a clear hot melt polyurethane layer.

9. The method according to claim 8, wherein the step of applying a top coat layer further includes applying a clear UV cured acrylic coating layer over the clear hot melt polyurethane layer.

10. The method according to claim 9, wherein the step of applying a top coat includes texturing the top coat.

11. The method according to claim 7, wherein the base layer is a vulcanized fiber sheet.

12. The method according to claim 7, wherein the ink is UV ink, and the step of applying ink include subjecting the ink to UV curing.

13. The method according to claim 7, further including securing the digitally printed decorative surfacing material to a substrate.

14. The method according to claim 7, wherein the step of applying a top coat includes texturing the top coat.
